(19) United States
(12) Patent Application Publication
(10) Pub. No.: US 2022/0378020 A1
(43) Pub. Date: Dec. 1, 2022

(54) INSECT REPELLANT ARTICLE AND METHOD FOR USING SAME

(71) Applicant: Annelise Jolie CHAVEZ, Hayden, ID (US)

(72) Inventor: Annelise Jolie CHAVEZ, Hayden, ID (US)

(21) Appl. No.: 17/331,329

(22) Filed: May 26, 2021

(51) Int. Cl. A01K 27/00; A61D 7/00; A01N 65/22; A01N 25/34; A01M 29/12

(52) U.S. Cl. CPC A01K 27/007; A61D 7/00; A01N 65/22; A01N 25/34; A01M 29/12; A01K 27/001; A01K 27/002; A01K 27/003

(57) ABSTRACT

Insect repellant articles and the use of the insect repellant articles. In accordance with certain embodiments, the insect repellant article comprises scent releasing component capable of deterring insects and/or other pests. The insect repellant articles are particularly useful in repelling insects such as bees, which can cause allergic reactions in pets or other animals.

### BACKGROUND

The present application relates to insect repellant articles and the use of the insect repellant articles. In accordance with certain embodiments, the insect repellant article comprises scent releasing component capable of deterring insects and/or other pests. The insect repellant articles are particularly useful in repelling insects such as bees, which can cause allergic reactions in pets or other animals.

### SUMMARY

According to aspects of the present disclosure, an insect repellant article is disclosed. In accordance with one embodiment, the insect repellant article includes a scent releasing component, wherein the scent releasing component contains at least one essential oil having a scent capable of repelling insects. The scent releasing component releases the scent from the essential oil to an area around the wearable article in a concentration sufficient to repel insects or other pests from the area.

In accordance with one embodiment, the insect repellant article is a wearable article such as a collar, leash or harness.

In accordance with one embodiment, the essential oil is selected from the group consisting of almond bitter oil, anise oil, basil oil, bay oil, caraway oil, cardamom oil, cedar oil, celery oil, chamomile oil, cinnamon oil, citronella oil, clove oil, coriander oil, cumin oil, dill oil, eucalyptus oil, fennel oil, ginger oil, grapefruit oil, lemon oil, lime oil, mint oil, parsley oil, peppermint oil, pepper oil, rose oil, spearmint oil (menthol), sweet orange oil, thyme oil, turmeric oil, oil of wintergreen and mixtures thereof. In accordance with one embodiment, the essential oil comprises at least one of citronella oil, eucalyptus oil, and peppermint oil. In some embodiments, the essential oil is peppermint oil.

In accordance with one embodiment, the scent releasing component comprises a heat activated scent releasing component.

In accordance with one embodiment, the scent releasing component comprises a scent impregnated material. In accordance with certain embodiments, the scent impregnated material is selected from the group consisting of a polymer, a fibrous material, an absorbent material and combinations thereof.

In accordance with one embodiment, the scent releasing component comprises a cartridge containing the essential oil. In accordance with certain embodiments, the cartridge is refillable. In accordance with certain embodiments, the cartridge is disposable.

In accordance with one embodiment, the scent releasing component includes a fan to facilitate release of the scent.

In accordance with one embodiment, the scent releasing component comprises a heating element to facilitate release of the scent.

In accordance with one embodiment, the scent releasing component comprises a power source. In accordance with certain embodiments, the power source includes a battery. In accordance with certain embodiments, the power source includes a solar cell.

In accordance with one embodiment, the insect repellant article further includes a compartment for medicine. In accordance with certain embodiments, the medicine may be useful in treating or alleviating an allergic reaction, such as that from a bee sting.

In accordance with one embodiment, a method for repelling insects is disclosed. In accordance with one aspect, the method includes securing the insect repellant article described herein.

### BRIEF DESCRIPTION OF THE FIGURES

FIG. 1 illustrates a schematic drawing of an insect repellant article in accordance with one embodiment.

FIG. 2 illustrates a schematic drawing of an insect repellant article in accordance with another embodiment.

### DETAILED DESCRIPTION

The following are definitions of terms used in the present specification. The initial definition provided for a group or term herein applies to that group or term throughout the present specification individually or as part of another group, unless otherwise indicated.

As used herein the term “about” is used herein to mean approximately, roughly, around, or in the region of. When the term “about” is used in conjunction with a numerical range, it modifies that range by extending the boundaries above and below the numerical values set forth. In general, the term “about” is used herein to modify a numerical value above and below the stated value by a variance of 20 percent up or down (higher or lower).

As used herein, the term “essential oil” means any class of volatile oils obtained from plants possessing the odor and other characteristic properties of the plant. The term also includes synthetically-made compounds that have the same chemical attributes. The essential oil usually carries the odor or flavor of the plant. Chemically, each plant essential oil or derivative thereof generally contains, as a major constituent, an acyclic monoterpene alcohol or aldehyde, a benzenoid aromatic compound containing at least one oxygenated substituent or side chain, or a monocarbocyclic terpene generally having a six-membered ring bearing one or more oxygenated substituents. As used herein, “essential oil” also includes derivatives thereof, including racemic mixtures, enantiomers, diastereomers, hydrates, salts, solvates, metabolites, analogs, and homologs.

Examples of such essential oils or their constituents include, but are not limited to, almond bitter oil, anise oil, basil oil, bay oil, caraway oil, cardamom oil, cedar oil, celery oil, chamomile oil, cinnamon oil, citronella oil, clove oil, coriander oil, cumin oil, dill oil, eucalyptus oil, fennel oil, ginger oil, grapefruit oil, lemon oil, lime oil, mint oil, parsley oil, peppermint oil, pepper oil, rose oil, spearmint oil (menthol), sweet orange oil, thyme oil, turmeric oil, and oil of wintergreen. Examples of active ingredients in essential oils include, but are not limited to, citronellal, methyl salicylate, ethyl salicylate, propyl salicylate, citronellol, safrole, and limonene.

Essential oils can be pure single compounds, for example, wintergreen oil (methyl salicylate). However, other essential oils are mixtures of compounds. For example, the following essential oils are mixtures of compounds: turpentine oil (pinene and dipentene); bitter almond oil (benzaldehyde and hydrocyanic acid); lavender oil (including bomeol, fenchol, linalol, α-terpineol, terpinen-4-ol, geranyl acetate, linanyl acetate, terpenyl acetate, camphor, 1,8-cineole, camphene, limonene), pinene (3-caryophyllene, farnascene and coumarin); and tea tree oil (including linalol, α-terpineol, terpinen-4-ol, 1,8-cineole, limonene, myrcene, phellandrene, pinene, α-terpene, -caryophyllene and sabinene). Exemplary methods for deriving an essential oil include steam distillation, pressing fruit rinds, solvent extraction, macerating the flowers and leaves in fat and treating the fat with solvent, enfleurage and synthetically.

“Insect repellent” means any chemical that prevents or discourages insects from landing in the vicinity of the chemical or detrimentally affects them if they enter the vicinity.

This present application relates to methods and devices for repelling insects. Various subjects including humans, pets such as cats and dogs, livestock such as cattle, pigs, horses, and sheep, and wild animals may benefit from the methods and devices disclosed herein.

In accordance with one embodiment, the present application discloses an insect repellant article capable of repelling insects. The insect repellent article may comprise a wearable article for a pet. The insect repellant article includes a scent releasing component, wherein the scent releasing component includes at least one essential oil having a scent capable of repelling insects. The scent releasing component releases the scent from the essential oil in an amount and over a period of time sufficient to repel insects away from an area in the immediate vicinity of insect repellant article or the wearer of the wearable article.

The essential oils disclosed herein may be formulated into and released at an effective amount from the scent releasing component with their formulations in either the form of a liquid, a solid, a gel, or any combination thereof. In accordance with certain aspects, the essential oil(s) may be the only active ingredient in such formulation. The “active” ingredient is the material responsible for repellency of the insects. Other ingredients may be added for controlling volatility or to provide fragrance or other desirable properties. The essential oils can be passively released or actively released by the scent releasing component.

In accordance with one aspect, the essential oils can be passively released from an cartridge containing the essential oil(s). The essential oil(s) can be contained in the cartridge in liquid form and releases through permeable slots or opening in the cartridge. The cartridge can be replaceable, refillable and/or disposable.

In accordance with one aspect, the essential oils can be passively released from a material impregnated with the essential oil(s). The scent releasing component can be a cartridge that is used to control the release rate of volatilization of the essential oil(s). The cartridge can be a container having a space therein to house a material onto which one or more of the essential oils is impregnated. The material typically has sufficient free void space to take in or absorb a quantity of essential oils sufficient to achieve a desired release profile over time. Suitable materials can be fibrous, porous, solids, or flexible materials. Suitable materials may include such absorbent materials such as paper, porous plastics, absorbent minerals, carbon, and the like.

The release of the scent from the essential oil(s) is dependent upon many variables including time and temperature with respect to the environment inside and outside of the vehicle. The essential oil(s) and impregnated material composition may comprise from about 10% to 99.5% by weight of a suitable impregnatable material and from about 0.5% to 90% by weight of essential oil(s).

The cartridge can have an opening on the outer surface thereof to permit the vapors emitted from the essential oil or oils to escape the cartridge. In accordance with some aspects, the cartridge provides for partially or fully closing the opening to allow the user of the cartridge to control the amount of scent released or to shut off the cartridge. The cartridge can vary in its shape or size to accommodate short periods of efficacy or long periods of efficacy. Cartridges can come in sizes made to last days or weeks by altering the amount of essential oils and compounds that are loaded into the absorbent material and/or cartridge.

The active ingredient can also be incorporated into microcapsules that are formulated to release of scent under various conditions or over time. The essential oil(s) in liquid form can be enclosed within hollow shells of differing size and wall thickness which can be dissolved or ruptured at different intervals to provide a generally steady supply of scent exposed to the environment. Moreover, semipermeable shells which allow escape through the shell wall without shell rupture can also be used to control the release of a scent.

Another method of controlling the release of the scent from an insect repellant article is to use a homogeneous semipermeable material containing the active ingredient as a pure impregnate, solute or precipitate. The semipermeable material serves as the carrier from which it can only slowly escape by solution, diffusion, evaporation or combinations thereof. The characteristics of the carrier material depends on properties such as pore size, compatibility with the environment, liquid content, temperature of environment, wet-ability, and processing parameters.

The active ingredient may be incorporated into or onto a part of the insect repellant article. The active ingredient may be contained in cartridges or pockets, which may be made of or contain areas of a mesh material allowing for air to flow readily there through. For example, the mesh may be fabricated from paper, cloth, synthetic material and combinations thereof such as fiberglass, nylon, polyester, polyethylene or the like. Moreover, a fibrous material or film including openings therein may also be substituted for the mesh.

In accordance with another embodiment, the active ingredient (essential oil(s)) may be incorporated into a structure or cartridge mounted on the insect repellant article at one or more locations. The structure may be in the form of strips, blocks, bars, tabs or the like adhering to the insect repellant article. The cartridge can have, for example, a flat shape such as a pad or disc or a three-dimensional shape such as hollow shape e.g., a tube or honeycomb. In one embodiment of the invention, the cartridge can have the form of a hollow tube. The structure or cartridge containing the active ingredient may be attached to the pest repellant article using those methods typically used to attach or secure these types of structures. For example, a cartridge or other structure incorporating the active ingredient may include a clip or other means of attachment, such as an adhesive, glue, hook and loop fasteners, a loop, a slit and the like for securing to the pest repellant article.

In accordance with some embodiments, the active ingredient may be actively dispersed. Actively dispersing a composition can facilitate dispersion of the active to an area immediately around a subject to provide an effective amount sufficient to prevent insects from reaching (e.g., landing on) the subject. Actively dispersing means that energy is being applied to the composition to disperse it into the air around a subject. Active dispersion includes, but is not limited to, heating, air dispersion, introducing motion to the active ingredient.

Heating may be through a resistive heating element. A heated element can be positioned anywhere in the vicinity of the essential oil(s) to provide heat to the liquid to help vaporize it much faster. Natural convection from this heated element will help propel the scent from the oil(s) to the ambient air surrounding the insect repellant article. A fan can also be used with this heated element to provide maximum performance;

A fan can also be used separately from the heating element. The fan creates an airflow through the cartridge or other structure containing the essential oils, which assists the liquid to vaporize much faster and propels the fragrance from the reservoir to the ambient air surrounding the insect repellant article. The fan can be a variable speed device so that it can operate at any desired level.

In accordance with certain embodiments, the present invention is designed to use any type of available power source in order to maximize its usefulness for any circumstance. For example, the device can use both AC and DC power sources. Replaceable or rechargeable batteries can power the device for the situation where an AC source is unavailable. When available, an AC source can be used to charge the batteries.

The device can use a solar panel to provide power to the fan or heating element. The solar panel can be attached to the insect repellant article or incorporated into one or more exposed surfaces on the article. The solar panel can also be used to charge an optional battery.

The insect repellant article may also include a compartment for medicine. There are certain situations in which it would be advantageous to have at one's immediate access certain forms of medication, such as antidotes for insect stings for people or other animals extremely allergic to insect bites such as bee and wasp stings. Examples of other medications that may be needed in certain emergencies include aspirin for heart attacks and nitroglycerin tablets for angina attacks.

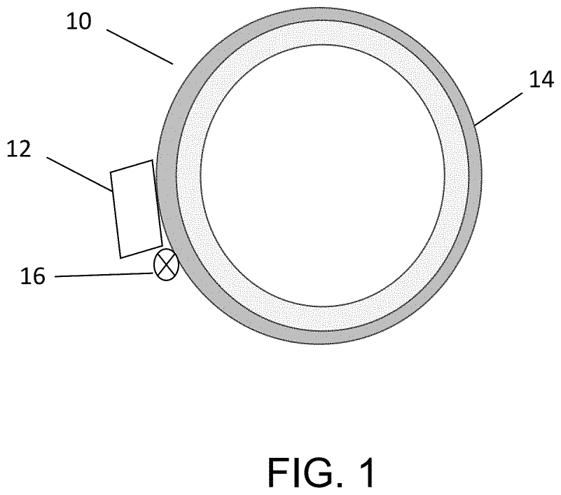

FIG. 1 illustrates a schematic drawing of an insect repellant article in accordance with one embodiment. As shown, insect repellant article 10 is a dog collar with a scent releasing component 12 for releasing at least one essential oil having a scent capable of repelling insects. In this case, the scent releasing component 12 is a cartridge containing a material impregnated with peppermint oil. The insect repellant article 10 may also include a solar panel 14 and a mini-fan 16. The solar panel may be a coating on the outer surface of the dog collar (as shown) or provided as a separate unit attached to the dog collar. The power output end of the solar panel 14 is connected to the power input of mini-fan 16 by a wire (not shown). The solar panel 14 absorbs solar energy and outputs electrical energy to supply power to mini-fan 16, which provides a stream of air over or through the oil impregnated material to disperse the scent therefrom.

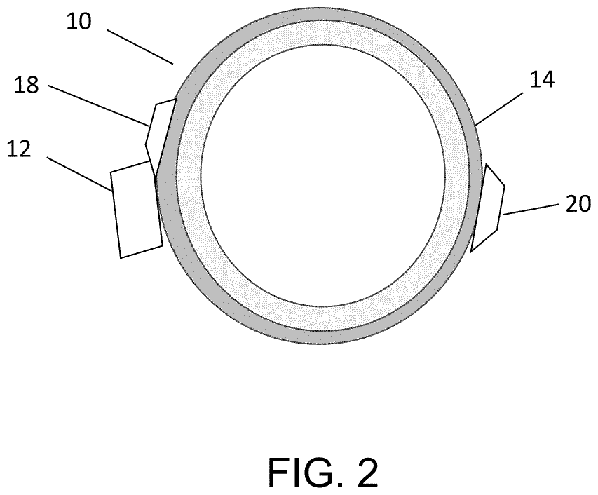

FIG. 2 illustrates a schematic drawing of an insect repellant article in accordance with another embodiment. As shown, insect repellant article 10 is a dog collar with a scent releasing component 12 for releasing at least one essential oil having a scent capable of repelling insects. In this case, the scent releasing component 12 is a cartridge containing a material impregnated with peppermint oil. The insect repellant article 10 may also include a solar panel 14 and a resistive heating element 18. The solar panel may be a coating on the outer surface of the dog collar (as shown) or provided as a separate unit attached to the dog collar. The power output end of the solar panel 14 is connected to the power input of resistive heating element by a wire (not shown). The solar panel 14 absorbs solar energy and outputs electrical energy to supply power to heating element 18, which heats the oil impregnated material to facilitate dispersion of the scent therefrom. The insect repellant article 10 in FIG. 2 also shows a medicine compartment 20, in which there may be carried a medicine for treatment for allergic reactions to insect stings or other emergency medication. In this manner, the medication is readily available to the wearer of insect repellant article 10.

In any embodiment herein, a composition may comprise a synergistic amount of one or more essential oils, one or more synthetic compounds, or any combination thereof, to provide a synergistic repellency, deterrent, or attraction-inhibitory effect. As used herein, a “synergistic amount” refers to an amount that produces greater than additive effects.

Any embodiment herein may comprise, consist essentially of, or consist of components, ingredients, steps, etc. With respect to “consist essentially of” such embodiments are drawn to the specified components, ingredients, steps, etc., and those that do not materially affect the basic and novel characteristics of the claimed invention. With respect to “consist of,” such embodiments are drawn to the specified components only.

The invention being thus described, it will be apparent that the same may be varied in many ways. Such variations are not to be regarded as a departure from the spirit and scope of the invention, and all such modifications as would be recognized by one skilled in the art are intended to be included within the scope of the following claims.

What is claimed is:

1. An insect repellant article comprising:
a wearable article for a pet said wearable article comprising a scent releasing component, wherein said scent releasing component comprises at least one essential oil having a scent capable of repelling insects, said scent releasing component capable of causing release of the scent from the essential oil to an area around the wearable article.

2. The insect repellant article of claim 1, wherein said wearable article is a collar, leash or harness.

3. The insect repellant article of claim 1, wherein said essential oil is selected from the group consisting of almond bitter oil, anise oil, basil oil, bay oil, caraway oil, cardamom oil, cedar oil, celery oil, chamomile oil, cinnamon oil, citronella oil, clove oil, coriander oil, cumin oil, dill oil, eucalyptus oil, fennel oil, ginger oil, grapefruit oil, lemon oil, lime oil, mint oil, parsley oil, peppermint oil, pepper oil, rose oil, spearmint oil (menthol), sweet orange oil, thyme oil, turmeric oil, oil of wintergreen and mixtures thereof.

4. The insect repellant article of claim 3, wherein said essential oil comprises at least one of citronella oil, eucalyptus oil, and peppermint oil.

5. The insect repellant article of claim 3, wherein said essential oil comprises peppermint oil.

6. The insect repellant article of claim 1, wherein the scent releasing component comprises a heat activated scent releasing component.

7. The insect repellant article of claim 1, wherein the scent releasing component comprises a scent impregnated material.

8. The insect repellant article of claim 7, wherein the scent impregnated material is selected from the group consisting of a polymer, a fibrous material, an absorbent material and combinations thereof.

9. The insect repellant article of claim 1, wherein the scent releasing component comprises a cartridge containing the essential oil.

10. The insect repellant article of claim 9, wherein the cartridge is refillable.

11. The insect repellant article of claim 9, wherein the cartridge is disposable.

12. The insect repellant article of claim 1, wherein the scent releasing component comprises a fan to facilitate release of the scent.

13. The insect repellant article of claim 1, wherein the scent releasing component comprises a heating element to facilitate release of the scent.

14. The insect repellant article of claim 1, wherein the scent releasing component comprises a power source.

15. The insect repellant article of claim 14, wherein the power source comprises a battery.

16. The insect repellant article of claim 14, wherein the power source comprises a solar cell.

17. The insect repellant article of claim 1, further comprising a compartment for medicine.

18. The insect repellant article of claim 17, wherein the medicine comprises medicine to treat an allergic reaction.

19. A method for repelling insects comprising:
securing the insect repellant article of claim 1 to an animal.
